(19) United States
(12) Patent Application Publication
(10) Pub. No.: US 2021/0291596 A1
(43) Pub. Date: Sep. 23, 2021

(54) Tire Tread

(71) Applicant: COMPAGNIE GENERALE DES ETABLISSEMENTS MICHELIN, Clermont-Ferrand (FR)

(72) Inventor: Nicolas HEROLD, Clermont-Ferrand Cedex 9 (FR)

(21) Appl. No.: 17/266,877

(22) PCT Filed: Aug. 7, 2019
(86) PCT No.: PCT/EP2019/071166

§ 371 Date: Feb. 8, 2021

(30) Foreign Application Priority Data
Aug. 9, 2018 (FR) 1857414

(51) Int. Cl. B60C 11/03; B60C 11/12; B60C 11/13

(52) U.S. Cl. CPC B60C 11/0323; B60C 11/1281; B60C 2011/1338; B60C 2200/06; B60C 2011/036; B60C 11/1315

(57) ABSTRACT

A tire tread for a heavy-duty vehicle which when new, has a maximum thickness of material to be worn away during running, a tread surface, side faces, a middle region (RM), this tread provided with tread pattern elements having channels, sipes, radial openings and blocking devices, the channels arranged in the tread and connected to the tread surface by radial openings arranged alternating with the blocking devices along the channels, where the tread is devoid of a circumferential groove, the channels arranged below the tread surface when the tread is new, the channels are transverse channels and connect RM to the side faces; each channel connecting the middle region to a side face has a direction change between RM and the side face; and maximum longitudinal distance between points of a transverse channel furthest apart in longitudinal direction is between 10% and 50% of the width of the tread (Lbdr).

### FIELD OF THE INVENTION

The invention relates to tire treads and more particularly to the tread patterns of these treads of which the performance in terms of clearing water in rainy weather is made more durable, these treads further exhibiting improved wear performance; this invention also relates to the tires provided with such treads.

### PRIOR ART

As is known, the conditions of running a heavy-duty vehicle in rainy weather require rapid evacuation of the water that can lie in the region in which the tire or, more particularly, the tread thereof, makes contact with the road surface. Evacuating the water makes it possible to ensure that the material forming the tread makes contact with this road surface. The water that is not pushed ahead of and to the sides of the tire flows or is collected partially in the cuts or voids formed in the tread of the tire.

These cuts or voids form a fluid flow network that needs to be durable, that is to say effective throughout the service life of a tire between its new state and its removal due to wear reaching a limit set by the manufacturer in accordance with the regulations in force.

For tires intended for the axles of a heavy-duty vehicle, it is common practice to form, in the tread of these tires, circumferential grooves (or longitudinal grooves), the depth of which is equal to the total thickness of the tread, this total thickness not taking into consideration the thickness that might be intended for allowing partial renewal of the grooves through an operation referred to as regrooving. Such longitudinal grooves make it possible to obtain a tread that has a water drainage performance that is always above a minimum performance referred to as the safe performance, this being true regardless of the level of wear of this tread within the limit set by the manufacturer.

For the tires of the prior art, the total voids volume when new is, as a general rule, between 10% and 25% of the total volume of the tread intended to be worn away during running (this total volume corresponding to the volume of wear material to which said total voids volume is added). These tires are found to have an available voids volume in the contact patch that is relatively high when new (available voids volume meaning that this volume is potentially able to be partially or completely filled with water present on the road surface). The volume of voids opening onto the tread surface in the contact patch is evaluated when the tire is subject to its usual inflation and load conditions as defined in particular by the E.T.R.T.O. standard for Europe. This standard states the reference inflation pressure corresponding to the load capacity of the tire indicated by its load index and its speed index. These use conditions can also be referred to as “nominal conditions” or “working conditions”.

While cuts or, more generally, cavities are essential to draining away water in the patch in contact with the road surface, the resulting reduction in the volume of material on the tread can substantially affect the wear performance of this tread and consequently can reduce the service life of the tire as a result of an increase in the wear rate of said tread.

Among the cuts that can be made in a tread by moulding, a distinction is made between grooves and sipes. Unlike grooves, sipes have an appropriate width so that the opposing walls that delimit them come at least partially into contact with one another when in the contact patch. Grooves bring about a substantial reduction in the compression and shear stiffnesses of the tread because these grooves delimit portions of material that can deform to a much greater extent than the portions delimited by sipes, the walls of which press against one another when in the contact patch. This decrease in stiffness, when grooves are present, causes an increase in deformation and can bring about a reduction in the wear performance of the tread. Greater wear is observed for a set distance covered and this corresponds to an increase in the wear rate of the tread. Furthermore, an increase in rolling resistance and therefore in fuel consumption of vehicles equipped with such tires is observed as a result of an increase in the hysteresis losses associated with the cycles of deformation of the material forming the tread.

Definitions:

The tread surface of a tread corresponds to all of the elementary surfaces of the tread that can come into contact with a road surface when a tire provided with such a tread is running

In the present document, a radial direction (Z) means a direction that is perpendicular to the axis of rotation of the tire (this direction corresponds to the direction of the thickness of the tread).

A transverse or axial direction (Y) means a direction parallel to the axis of rotation of the tire.

A circumferential or longitudinal direction (X) means a direction tangential to any circle centered on the axis of rotation. This direction is perpendicular both to the axial direction and to a radial direction.

A tread has a maximum thickness of material to be worn away (EMU) during running, defined between the tread surface when new and the legal wear limit, generally embodied by wear indicators situated 1.6 mm, for example, from the bottom of the grooves of the tread.

The equatorial mid-plane (PME) is a plane perpendicular to the axis of rotation dividing the tire into two equal halves.

The geometric measurements of the tread pattern elements to which the present application relates are established outside the contact patch when the tire is mounted on its reference rim and inflated to its reference pressure in the use conditions defined by the E.T.R.T.O standard.

### BRIEF SUMMARY OF THE INVENTION

The aim of the invention is to propose a tread having improved wear and rolling resistance performance while maintaining satisfactory traction and water evacuation performance throughout the use of the tread between its new state and its removal due to wear reaching the regulatory limit.

To this end, the invention proposes a tire tread for a heavy-duty vehicle comprising, when new, a maximum thickness of material to be worn away during running, a tread surface, side faces, a middle region, this tread being provided with tread pattern elements, said tread pattern elements comprising channels, sipes, radial openings and blocking devices, said channels being arranged in the thickness of the tread and connected to the tread surface by the radial openings, said radial openings being arranged alternating with said blocking devices along said channels, this tread being devoid of a circumferential groove, and in which:

the channels are arranged below the tread surface (11) when the tread is new;

the channels are transverse and connect the middle region of the tread to the side faces of the tread;

each transverse channel connecting the middle region to a side face comprises at least one change of direction between the middle region and the side face; and

a maximum longitudinal distance between the points of a transverse channel furthest apart in the longitudinal direction is between 10% and 50% of the width of the tread, and preferably between 10% and 30%.

Preferably, the blocking devices comprise contact faces with a length Lc in the direction of the underlying channel, said length Lc being between 10 mm and 40 mm

Preferably, the radial openings have, in the direction of the underlying channel, a length Lo where Lc≤Lo≤3*Lc.

Preferably, the blocking devices have a radial height of between 25% and 75% of the maximum thickness of material to be worn away during running.

Preferably, the blocking devices are situated at a radial distance from the tread surface of between 0 and 5 mm.

Preferably, the alternation of the radial openings and the blocking devices of one channel is axially offset relative to the alternation of the radial openings and blocking devices of the longitudinally adjacent channel.

Preferably, the distal faces of the blocking devices form an angle of between 90° and 150° with the mean direction of the contact faces of said blocking devices.

Preferably, the channels that open onto one side face of the tread are further connected in the middle region of the tread to the channels that open onto the other side face of the tread. Alternatively, the channels that open onto one side face of the tread are longitudinally offset in the middle region relative to the channels that open onto the other side face of the tread.

Preferably, the tread further comprises shoulder sipes oriented substantially longitudinally, situated at a distance Di from the side faces of the tread of between 15% and 25% of the width of the tread.

Preferably, said shoulder sipes connect radial openings of longitudinally adjacent channels.

Preferably, said shoulder sipes have a depth greater than 80% of the maximum thickness of material to be worn away and preferably a width of between 2 mm and 4 mm.

Preferably, the tread further comprises central sipes oriented substantially longitudinally, situated axially between the shoulder sipes.

Preferably, said central sipes connect radial openings of longitudinally adjacent channels.

Preferably, said central sipes have a depth greater than 80% of the maximum thickness of material to be worn away and preferably a width less than 1.5 mm.

The invention also relates to a tire for a heavy-duty vehicle provided with a tread as described above.

Further features and advantages of the invention will become apparent from the following description provided with reference to the appended drawings which show, by way of non-limiting examples, embodiments of the subject matter of the invention.

### BRIEF DESCRIPTION OF THE FIGURES

FIG. 1 is a perspective view of a tire comprising a tread according to a first embodiment of the invention.

FIG. 2 is a front view of part of the tread in FIG. 1 when new.

FIG. 3 is a partial view similar to the view in FIG. 2, of the same tread after wear of a significant proportion of the maximum thickness of material to be worn away during running

FIG. 4 is a partial view similar to the view in FIG. 2 on a larger scale.

FIG. 5a is a partial detailed cross-sectional view along the line A-A in FIG. 4.

FIG. 5b is a partial detailed cross-sectional view along the line B-B in FIG. 4.

FIG. 5c is a partial detailed cross-sectional view along the line C-C in FIG. 4.

FIG. 5d is a partial detailed cross-sectional view along the line D-D in FIG. 4.

FIG. 5e is a partial detailed cross-sectional view along the line E-E in FIG. 4.

FIG. 5f is a view on a larger scale of detail F in FIG. 4.

FIG. 6 is a front view similar to the view in FIG. 2, of a tread according to a second embodiment of the invention.

FIG. 7 is a cross-sectional view along the broken line G-G in FIG. 6.

FIG. 8 is a front view similar to the views in FIGS. 2 and 6, of a tread according to a third embodiment of the invention.

### DESCRIPTION OF THE FIGURES

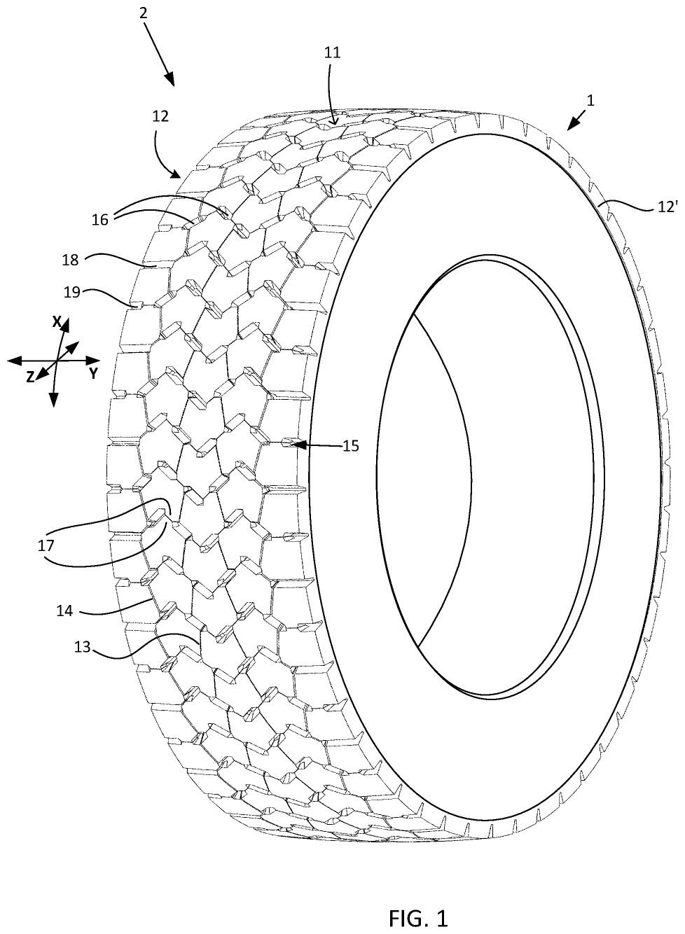

FIG. 1 shows a tire 2 for a heavy-duty vehicle comprising a tread 1 according to the invention. The tread comprises a tread surface 11, respective side faces 12 and 12′ and tread pattern elements such as sipes 13 and 14, transverse channels 15, radial openings 16 and transverse grooves 18. In the present application, a tread pattern element such as a channel or a groove is said to be transverse when its general orientation forms an angle of 45 degrees or more with the longitudinal direction X. The tread according to the invention is devoid of circumferential (longitudinal) grooves.

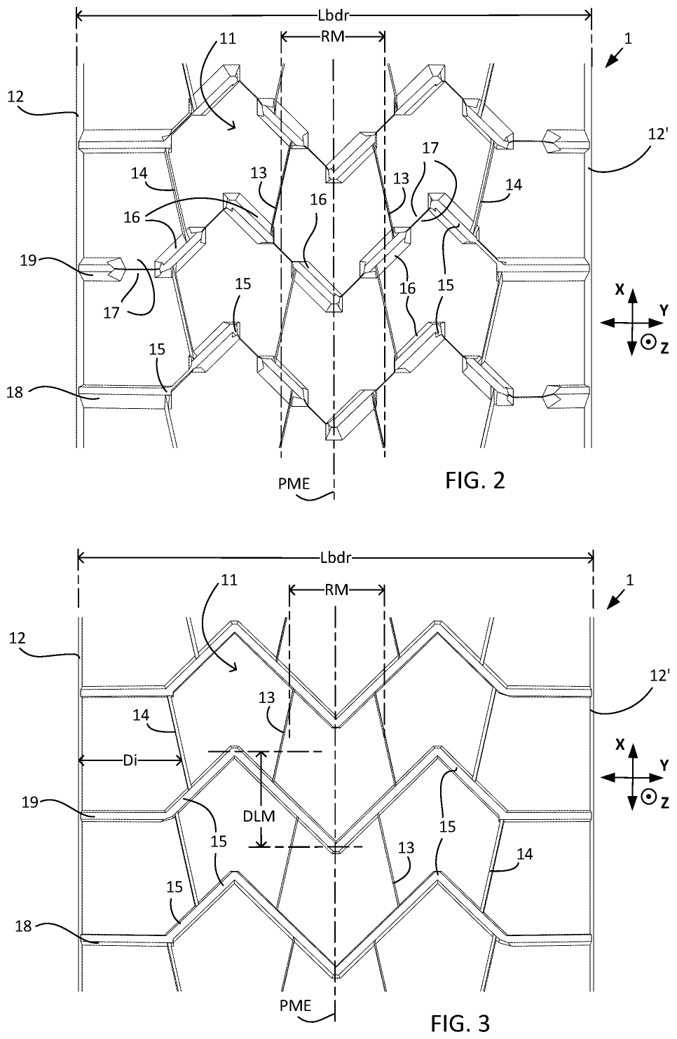

FIG. 2 shows a front view of a fraction of the tread in FIG. 1 on an enlarged scale that particularly makes it possible to distinguish more clearly the elements that form the tread pattern thereof. The tread is shown here when new. The tread is divided into two equal parts by the equatorial mid-plane PME. The region of the tread situated on either side of the equatorial mid-plane over a width corresponding to 20% of the width Lbdr of the tread is referred to as the middle region RM.

The transverse channels 15 are situated in the thickness of the material to be worn away, i.e., below the tread surface 11 when the tread is new. The radial openings 16 connect the transverse channels to the tread surface 11 in the radial direction. The transverse channels 15 can therefore be seen at the bottom of the radial openings. Blocking devices 17 are interposed between the successive radial openings along the transverse channels. The transverse channels 15 that are arranged at the bottom of the tread pattern connect the middle region RM of the tread to the side faces 12 and 12′ so that the water can be evacuated laterally from the contact patch. In this embodiment, the channels open onto the side faces in transverse grooves 18, 19.

Preferably, as can be seen clearly in this side view, the alternation of the radial openings and the blocking devices of one channel is axially (transversely) offset relative to the alternation of the radial openings and blocking devices of the longitudinally adjacent channel. Along a circumferential direction, a radial opening is thus substantially opposite a blocking device of the adjacent transverse channel, and vice versa.

FIG. 3 shows the same fraction of the tread as in FIG. 2, as it appears after a large part of the maximum thickness of material to be worn away has indeed been worn away. The partially worn tread shown here still includes approximately 5 mm of void, i.e., approximately 3.4 mm of material to be worn away remains before the legal limit of 1.6 mm, which corresponds to less than 20% of the maximum thickness of material to be worn away. The remaining part of the transverse channels that connect the middle region to the side faces can be seen more clearly in this figure. The blocking devices and therefore the contours of the radial openings have, at this stage of wear, completely disappeared. As described above, the transverse channels being arranged at the bottom of the tread pattern bring about open, continuous grooves at the end of wear. It can also be seen in this view that the channels comprise changes of direction between the middle region and the side face. In this embodiment, there are two changes of direction between the middle region and the side face. If the trajectory of a transverse channel between the middle region and the side face is observed, a maximum longitudinal distance DLM can be measured between the two points of the channel furthest apart in the longitudinal direction. According to the invention, the maximum longitudinal distance DLM is between 10% and 50% of the width of the tread Lbdr, and preferably between 10% and 30%. In the example shown here, the distance DLM is equal to 18.5% of Lbdr. The central sipes 13 and the shoulder sipes 14 are substantially longitudinal, the general orientation thereof forming an angle of 20° or less with the longitudinal direction X. These sipes connect two adjacent channels preferably at the radial openings and transverse grooves. The shoulder sipes 14 are situated at a distance Di from the side faces of the tread, Di being between 15% and 25% of the width Lbdr of the tread. The central sipes 13 are situated between the respective shoulder sipes 14, i.e., in a central zone of the tread representing at least 50% of the width Lbdr.

It can be seen clearly in FIG. 3 that in this embodiment, the transverse channels not only connect the side faces to the middle region of the tread, but also connect the side faces to each other, as the channels on the left-hand part of the tread are directly connected to the channels on the right-hand part. Another specific feature of this first embodiment is that the tread pattern is directional, i.e., it is not independent of the direction of rotation of the tire.

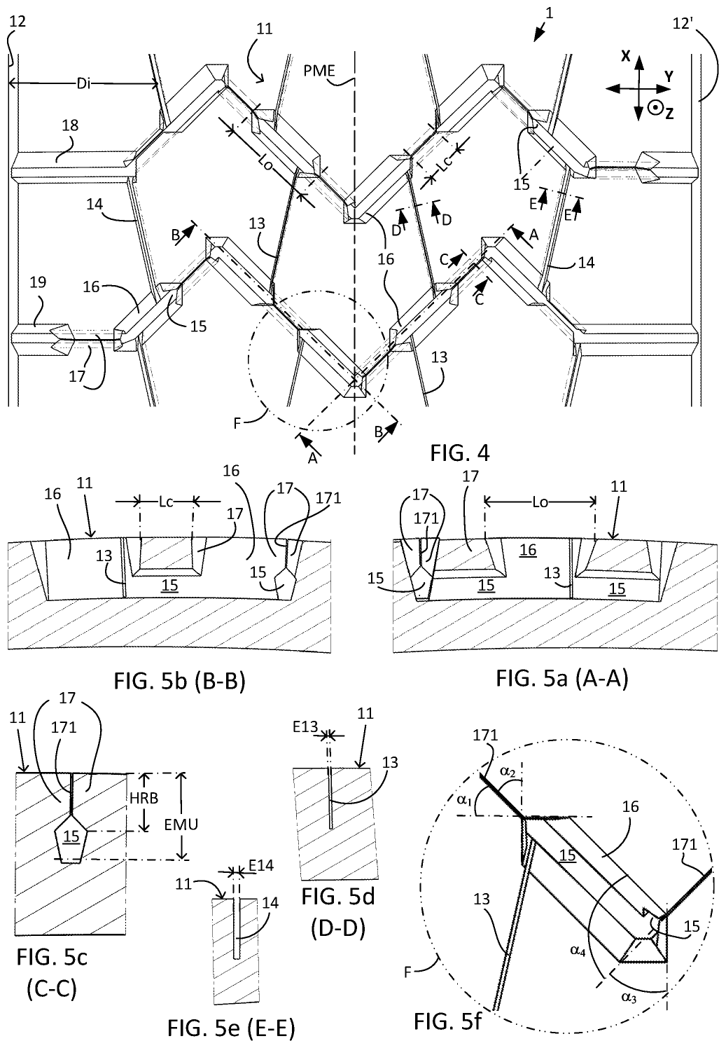

This first embodiment of the invention can be described more clearly with reference to FIG. 4 and the detailed cross-sectional views in FIGS. 5a to 5e. FIG. 4, which is similar to FIG. 2 but on a yet larger scale, shows the sections of the transverse channels 15 which, when the new tread is new, are hidden below the tread surface 11 by the blocking devices.

The blocking devices comprise contact faces with a length Lc. This length is measured in the direction of the underlying channel. If the contact faces are not parallel and straight as shown here, but curved for example, the length over which the faces are no more than 1.5 mm apart will be taken into consideration.

The radial openings have a length Lo. This length is measured in the direction of the underlying channel between two successive blocking devices along the channel If the contact faces of the blocking devices are not parallel and straight, but curved for example, the length over which the faces are more than 1.5 mm apart will be taken into consideration.

FIG. 5a is a cross-sectional view along the line A-A in FIG. 4, mainly showing the first part of the transverse channel connecting the middle region to the right-hand side face of the tread. Along the channel 15, this cross-section shows the alternation of two blocking devices 17 and one radial opening 16. On the left in this cross-section, the transverse channel 15 that connects the middle region to the left-hand side face of the tread can also be seen. Above this channel, the first blocking device 17 and the sipe 171 that separates the two opposite contact faces of the blocking device can be seen clearly. The central sipe 13 can also be seen, the radial height (depth) of which is equivalent to that of the channel.

FIG. 5b is a cross-sectional view along the line B-B in FIG. 4, mainly showing the first part of the transverse channel connecting the middle region to the left-hand side face of the tread. Along the channel 15, this cross-section shows the alternation of two radial openings 16 and one blocking device 17. On the right in this cross-section, the transverse channel 15 that connects the middle region to the right-hand side face of the tread can also be seen.

FIG. 5c is a cross-sectional view along the line C-C in FIG. 4, showing the transverse channel 15 in a part where it is not visible from the outside due to the presence of the blocking devices 17. Preferably, according to the invention, the width of the transverse channels is between 4 and 10 mm, and more preferably between 6 and 8 mm In the embodiment shown here, the channel has a width of approximately 7 mm at its widest part, situated radially on the outside, and of approximately 5 mm at its radially inner part. Preferably, the blocking devices form, as shown here, part of the contact surface 11 when new, i.e., they come into contact with the road surface. However, in a manner known per se, they can also be offset below the contact surface, by a radial distance that is preferably no greater than 5 mm.

The radial height HRB of the blocking devices preferably represents 25 to 75% of the maximum thickness of material to be worn away. In this example, HRB represents approximately 65% of the maximum thickness of material to be worn away EMU.

It can be seen clearly in the cross-section in FIG. 5c that in this part, the channel that is not visible when new will start to appear on the tread surface when the wear of the tread has removed the thickness corresponding to the height of the contact faces of the blocking devices 17.

FIG. 5d is a cross-sectional view along the line D-D in FIG. 4, showing a central sipe 13. Here, the width of the central sipes is less than 1 mm and the depth (radial height) thereof, as stated above, corresponds substantially to the maximum thickness of material to be worn away.

FIG. 5e is a cross-sectional view along the line E-E in FIG. 4, showing a shoulder sipe 14. Here, the width of the shoulder sipes is approximately 2.5 mm and the depth thereof corresponds substantially to the maximum thickness of material to be worn away. In the case of sipes close to the side faces of the tread, an appropriate width so that the walls of the sipe definitely come into contact when in the contact patch is between 2 mm and 4 mm.

FIG. 5f is a view of detail F in FIG. 4 particularly showing a radial opening 16 on a yet larger scale. This view makes it possible to illustrate the angle α formed between the distal faces of the blocking devices and the mean direction of the contact faces of said blocking devices 17. The angle α is preferably between 90° and 150° according to the invention. This figure shows α₁, α₂ and α₃, which equal approximately 135° and α₄, which equals approximately 90° . This view also more clearly shows the start of the concealed part of the transverse channel 15 that extends below the blocking device and its sipe 171.

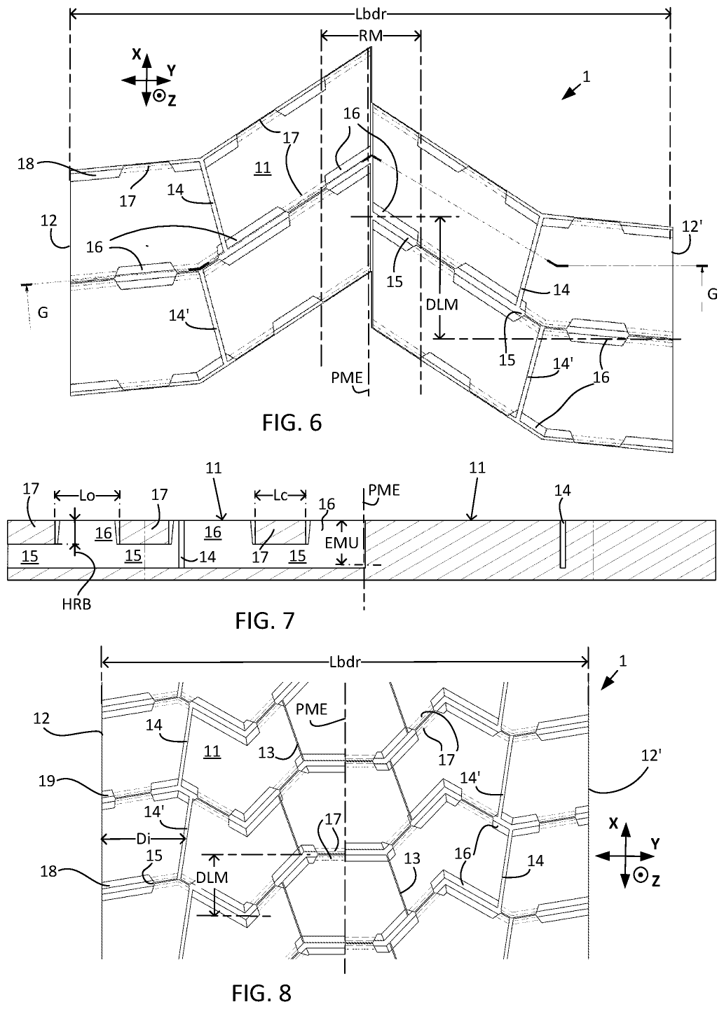

FIG. 6 is a similar view to FIG. 4, showing the principles of a second embodiment of a tread according to the invention, with FIG. 7 being a cross-sectional view along the broken line G-G in FIG. 6. In this embodiment, the transverse channels on the left-hand part of the tread are interposed with the channels on the right-hand part and are not connected to each other in the middle region. Here, each channel only has one change of direction between the middle region and the side face that it connects it to. Furthermore, this embodiment comprises shoulder sipes 14, 14′ but does not comprise a central sipe. As applicable, said shoulder sipes connect two radial openings (configuration of the sipe 14) of two adjacent channels or one radial opening to a blocking device 17 (configuration of sipe 14′). In this embodiment, DLM equals 20.5% of Lbdr.

Here too, the alternation of the radial openings and blocking devices of one channel is offset axially relative to the alternation of the radial openings and blocking devices of the longitudinally adjacent channel so that along a circumferential direction, a radial opening is thus substantially opposite a blocking device of the adjacent channel, and vice versa.

FIG. 7 also makes it possible to clearly show the geometric measurements of the blocking devices (height HRB and length Lc) and of the radial openings (length Lo).

FIG. 8 is a similar view to FIG. 4, showing the principles of a third embodiment of a tread according to the invention. In this embodiment, the transverse channels on the left-hand part of the tread are once more connected to the channels on the right-hand part and are therefore connected to each other in the middle region. Here, the channels have three changes of direction between the middle region and the side face that is connected thereto. Furthermore, this embodiment comprises shoulder sipes 14, 14′ similar to those in the embodiment in FIG. 6 and central sipes 13 similar to those in the embodiment in FIG. 4.

In this embodiment, DLM equals 12.5% of Lbdr. Another specific feature of this embodiment is that the pattern is non-directional, i.e., it is independent of the direction of rotation of the tire.

The invention described above is of course not limited to these variants alone, and various modifications can be made thereto while still remaining within the scope defined by the claims.

1. A tread of a tire for a heavy-duty vehicle comprising, when new, a maximum thickness of material to be worn away during running (EMU), a tread surface, side faces, a middle region (RM), this tread being provided with tread pattern elements, said tread pattern elements comprising channels, sipes, radial openings and blocking devices, said channels being arranged in the thickness of the tread and connected to the tread surface by the radial openings, said radial openings being arranged alternating with the blocking devices along said channels, this tread being it is devoid of a circumferential groove, and wherein:
the channels are arranged below the tread surface when the tread is new;
the channels are transverse and connect the middle region of the tread to the side faces of the tread;
each transverse channel connecting the middle region to a side face comprises at least one change of direction between the middle region and said side face; and
a maximum longitudinal distance (DLM) between the points of a transverse channel furthest apart in the longitudinal direction is between 10% and 50% of the width of the tread (Lbdr), and preferably between 10% and 30%.

2. The tread according to claim 1, wherein the blocking devices comprise contact faces with a length Lc in the direction of the underlying channel, said length Lc being between 10 mm and 40 mm.

3. The tread according to claim 2, wherein the radial openings have, in the direction of the underlying channel, a length Lo where Lc≤Lo≤3*Lc.

4. The tread according to claim 1, wherein the blocking devices have a radial height HRB of between 25% and 75% of the maximum thickness of material to be worn away during running (EMU).

5. The tread according to claim 1, wherein the blocking devices are situated at a radial distance from the tread surface of between 0 and 5 mm.

6. The tread according to claim 1, wherein the alternation of the radial openings and the blocking devices of one channel is axially offset relative to the alternation of the radial openings and blocking devices of the longitudinally adjacent channel.

7. The tread according to claim 1, wherein the distal faces of the blocking devices form an angle (α) of between 90° and 150° with the mean direction of the contact faces of said blocking devices.

8. The tread according to claim 1, wherein the channels that open onto one side face of the tread are further connected in the middle region of the tread to the channels that open onto the other side face of the tread.

9. The tread according to claim 1, wherein the channels that open onto one side face of the tread are longitudinally offset in the middle region relative to the channels that open onto the other side face of the tread.

10. The tread according to claim 1, further comprising shoulder sipes oriented substantially longitudinally, situated at a distance Di from the side faces of the tread of between 15% and 25% of the width of the tread (Lbdr).

11. The tread according to claim 10, wherein said shoulder sipes connect radial openings of longitudinally adjacent channels.

12. The tread according to claim 10, wherein said shoulder sipes have a depth greater than 80% of the maximum thickness of material to be worn away (EMU).

13. The tread according to claim 10, further comprising substantially longitudinally oriented central sipes situated axially between the shoulder sipes and preferably connecting radial openings of longitudinally adjacent channels.

14. The tread according to claim 13, wherein said central sipes have a depth greater than 80% of the maximum thickness of material to be worn away (EMU).

15. A tire for a heavy-duty vehicle provided with a tread according to claim 1.
